(19) United States
(12) Patent Application Publication
(10) Pub. No.: US 2008/0277074 A1
(43) Pub. Date: Nov. 13, 2008

(54) Roman shade with movable top rail

(76) Inventor: Tzong-Fu Lin, Taipei (TW)

Correspondence Address: BRUCE H. TROXELL;SUITE 1404, 5205 LEESBURG PIKE, FALLS CHURCH, VA, 22041, US

(21) Appl. No.: 11/798,050

(22) Filed: May 9, 2007

(51) Int. Cl. E06B 9/26

(52) U.S. Cl. 160/166.1

(57) ABSTRACT

A Roman shade includes a head beam; a top rail located below the head beam; a shade body having an upper portion attached to the top rail; and a lift control unit including a plurality of lift locks mounted on the head beam for controlling the top rail and the shade body to stop at any desired lifted position, a plurality of first lift cords passed through one of the lift locks to fasten to a lower portion of the shade body, and a plurality of second lift cords passed through the other lift lock to fasten to the top rail. When the first lift cords are pulled to different extents, the shade body is lifted or lowered; and when the second lift cords are pulled to different extents, the top rail is caused to move toward or away from the head beam.

### FIELD OF THE INVENTION

The present invention relates to a Roman shade, and more particularly to a Roman shade having a movable top rail, which is controllable via a second set of lift cords to move toward or away from a fixed head beam, so that a user may view outdoor scenery via a space between the head beam and the downward moved top rail when a shade body hung from the top rail is in a lowered position.

### BACKGROUND OF THE INVENTION

Window shades are used in modern living to shut out light and protect privacy. A conventional Roman shade includes a head beam and a fabric shade connected to and hung from a bottom of the head beam. A plurality of braking members is mounted to the bottom of the head beam, and a plurality of lift cords are passed through the braking members. The fabric shade is formed from a plurality of vertically connected transverse pieces. At least one row of holes is provided on the transverse pieces, so that the lift cords may be extended through the row of holes to fasten to the lowest hole in the row. Whereby, when the lift cords are pulled, the fabric shade is brought to lift or lower.

When the fabric shade is fully lowered, the window is completely shut and a user could not see outdoor scenes via the window. When it is desired to view outdoor scenes via the window, the fabric shade must be lifted. However, once the Roman shade is lifted, it fails to provide any shielding function. Therefore, the conventional Roman shade does not provide changeful and optional functions to meet the requirements in modern living.

### SUMMARY OF THE INVENTION

A primary object of the present invention is to provide a Roman shade having a movable top rail, so that a user may view outdoor scenery via a space between a fixed head beam and the downward moved top rail while the Roman shade has been lowered.

To achieve the above and other objects, the Roman shade with movable top rail according to the present invention includes a head beam; a top rail located below the head beam; a shade body having an upper portion attached to the top rail; and a lift control unit including a plurality of lift locks, a plurality of first lift cords, and a plurality of second lift cords. The lift locks are mounted on the head beam. The plurality of first lift cords are passed through one of the lift locks to fasten to a lower portion of the shade body, and the plurality of second lift cords are passed through the other lift lock to fasten to the top rail. When the first lift cords are pulled, the lift lock causes the shade body to stop at a desired lifted or lowered position, and when the second lift cords are pulled, the top rail is caused to move toward or away from the head beam by a desired distance.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is an assembled rear perspective view of a Roman shade according to the present invention with a shade body thereof in a fully lowered position;

FIG. 2 is an exploded front perspective view of the Roman shade of FIG. 1;

FIG. 3 is a rear perspective view of the Roman shade of FIG. 1 with the shade body in a fully lifted position;

FIG. 4 is a rear perspective view of the Roman shade of FIG. 1 with the shade body in a partially lifted position;

FIG. 5 is a rear perspective view of the Roman shade of FIG. 1 with the shade body fully lowered and downward moved to a position lower than a decorative valance; and

FIG. 6 shows the Roman shade of FIG. 5 with the shade body in a fully lifted position.

### DETAILED DESCRIPTION OF THE PREFERRED EMBODIMENTS

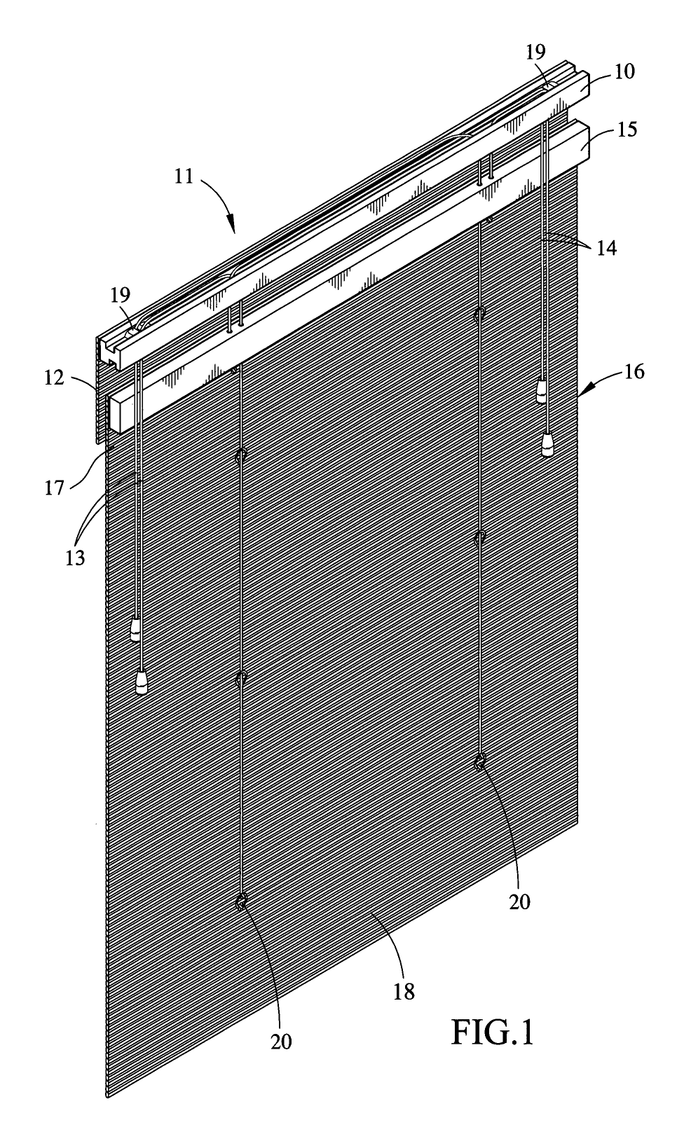

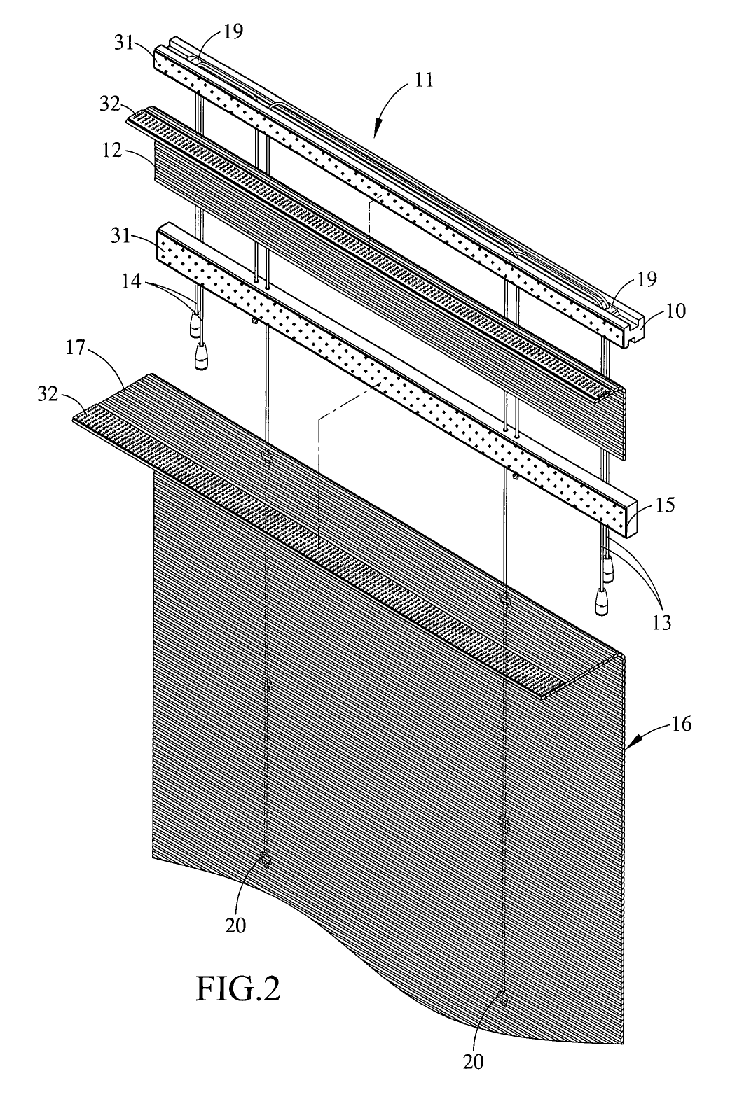

Please refer to FIGS. 1 and 2 that are assembled rear and exploded front perspective views, respectively, of a Roman shade with movable top rail according to a preferred embodiment of the present invention. As shown, the Roman shade of the present invention includes a head beam 10, a lift control unit 11, a top rail 15 located below the head beam 10, and a shade body 16. The shade body 16 may be made of different materials, such as wood, bamboo, fabric, and other suitable materials. In the illustrated embodiment, the shade body 16 is made of a bamboo material, and includes a plurality of transverse bamboo rods. The shade body 16 has an upper portion 17 attached to a front side of the top rail 15, and a lower portion 18. At least one row of rings 20 are provided on the shade body 16.

The shade body 16 and a decorative valance 12 are detachably connected to a front side of the top rail 15 and the head beam 10, respectively, via a self-adhesive mechanism. The self-adhesive mechanism includes a hook tape 31 connected to the front side of the head beam 10 and the top rail 15, and a loop tape 32 connected to an upper edge of the decorative valance 12 and the upper portion 17 of the shade body 16 at one side facing the head beam 10 and the top rail 15, respectively. The decorative valance 12 and the shade body 16 may be easily and firmly attached to the head beam 10 and the top rail 15, respectively, simply by pressing the loop tape 32 against the hook tape 31. The loop tape 32 may be detached from the hook tape 31 by a suitable pull force, so as to separate the shade body 16 and the decorative valance 12 from the top rail 15 and the head beam 10, respectively.

The lift control unit 11 includes a plurality of lift locks 19 mounted in the head beam 10 for controlling the top rail 15 and the shade body 16 to stop at any desired lifted position; and a plurality of first lift cords 13, each of which has an end upward extended through one of the lift locks 19 into the head beam 10 and then downward extended through the top rail 15 at a predetermined position to extend through one row of the rings 20 and be fastened to a lowest one of the rings in the row, so that the first lift cords 13 are associated with the shade body 16 to control the lifting or lowering of the shade body 16; and a plurality of second lift cords 14, each of which has an end upward extended through the other lift lock 19 into the head beam 10 and then downward extended through and fastened to the top rail 15 at another predetermined position.

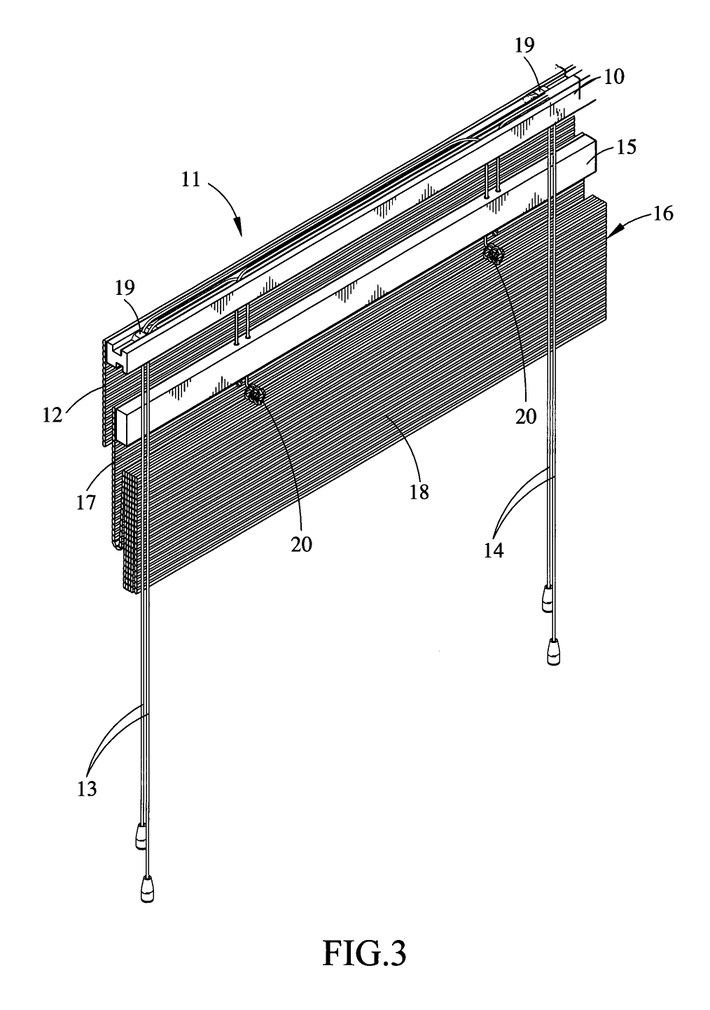

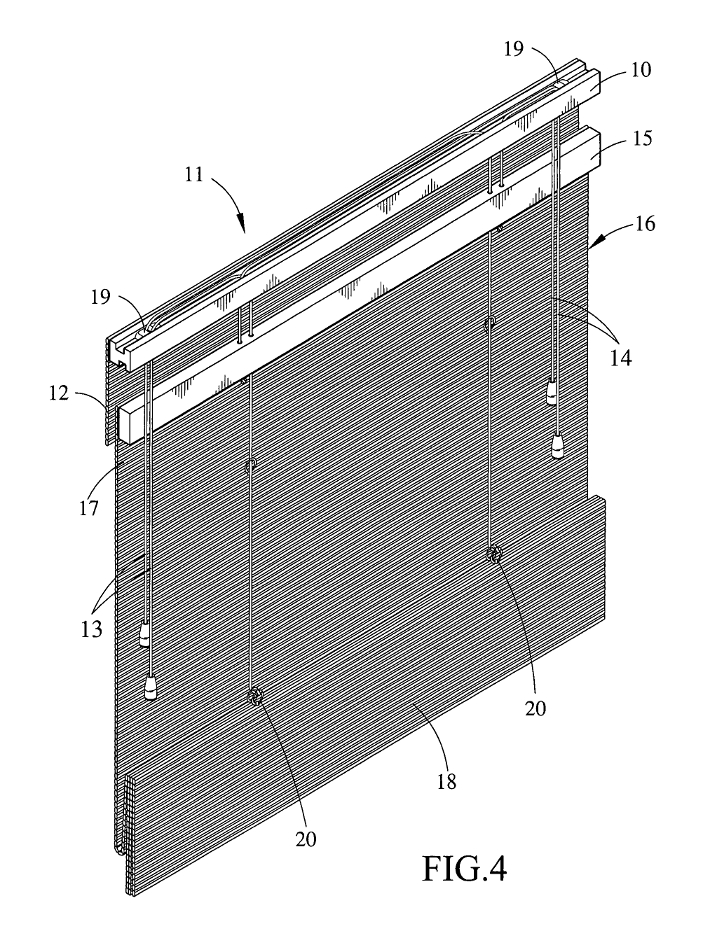

Please refer to FIGS. 3 and 4. The first lift cords 13 may be downward pulled to lift the shade body 16 from a fully lowered position as shown in FIG. 1 to a fully lifted position as shown in FIG. 3, or to a partially lifted position as shown in FIG. 4. When the shade body 16 is in the fully lifted position as shown in FIG. 3, light is admitted into a house and a user may view outdoor scenery.

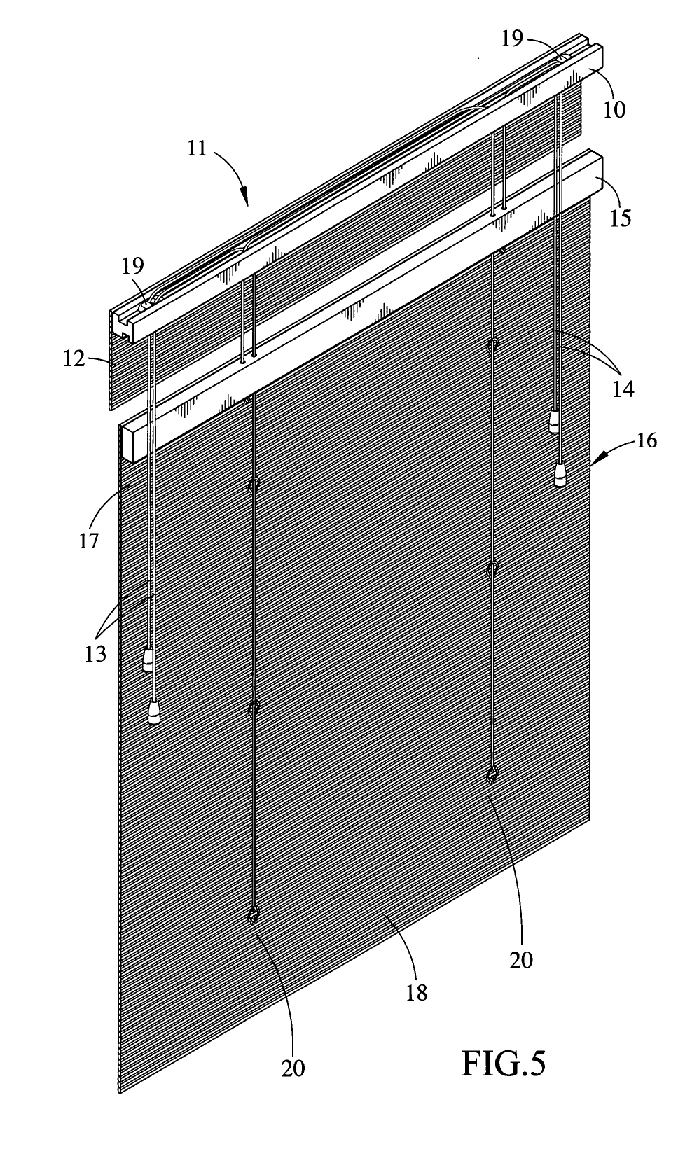

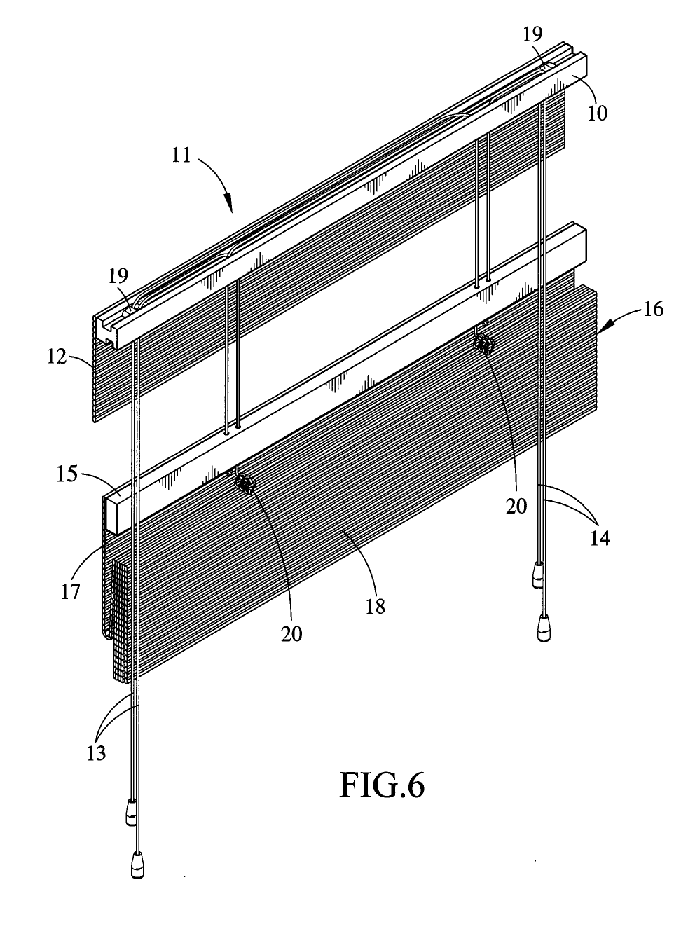

The second lift cords 14 are used to control a distance between the top rail 15 and the head beam 10. By pulling the second lift cords 14 to different extents, the top rail 15 may be moved to different positions relative to the head beam 10, such as a position closer to the head beam as shown in FIG. 1, or a position farther away from the head beam as shown in FIG. 5. When the top rail 15 is moved upward or downward with the second lift cords 14, the shade body 16 connected to the top rail 15 is moved at the same time. A user may select to have the shade body 16 in a fully lowered position while the top rail 15 is moved away from the head beam 10, as shown in FIG. 5; or have the shade body 16 in a lifted position while the top rail 15 is moved away from the head beam 10, as shown in FIG. 6. Via the space between the head beam 10 and the downward moved top rail 15, a user may enjoy outdoor scenery.

The decorative valance 12 is detachably connected to the front side of the head beam 10, so that parts of the Roman shade located below the head beam 10 are invisibly located behind the decorative valance 12.

With the above arrangements, the Roman shade according to the present invention includes a movable top rail 15 that may be moved toward or away from the head beam 10, so that a user may view outdoor scenery via a suitably adjusted space between the top rail 15 and the head beam 10. The Roman shade of the present invention therefore has rich and changeful functions to meet the living requirements in modern life.

The present invention has been described with a preferred embodiment thereof and it is understood that many changes and modifications in the described embodiment can be carried out without departing from the scope and the spirit of the invention that is intended to be limited only by the appended claims.

What is claimed is:

1. A Roman shade with movable top rail, comprising:
a head beam having a front side;
a top rail located below the head beam;
a shade body having an upper portion attached to the top rail, and a lower portion; and
a lift control unit including a plurality of lift locks mounted on the head beam for controlling the top rail and the shade body to stop at any desired lifted position; a plurality of first lift cords, each of which has an end upward extended through one of the lift locks to fasten to the lower portion of the shade body; and a plurality of second lift cords, each of which has an end upward extended through the other lift lock to fasten to the top rail;
whereby when the first lift cords are pulled to different extents, the shade body is caused to lift or lower, and when the second lift cords are pulled to different extents, the top rail is caused to move toward or away from the head beam.

2. The Roman shade with movable top rail as claimed in claim 1, further comprising a decorative valance attached to the front side of the head beam.

3. The Roman shade with movable top rail as claimed in claim 1, wherein the first lift cords are extended through the lift lock into the head beam and then downward extended through the top rail to fasten to the lower portion of the shade body.

4. The Roman shade with movable top rail as claimed in claim 1, wherein the second lift cords are extended through the lift lock into the head beam and then downward extended through the top rail to fasten to the top rail.

5. The Roman shade with movable top rail as claimed in claim 1, wherein the shade body is provided with at least one row of rings, through which the first lift cords are downward extended to fasten to the lowest one of the rings in the row.

6. The Roman shade with movable top rail as claimed in claim 1, wherein the upper portion of the shade body is detachably attached to the top rail via a self-adhesive mechanism.

7. The Roman shade with movable top rail as claimed in claim 2, wherein the decorative valance is detachably attached to the front side of the head beam via a self-adhesive mechanism.
